(19) United States
(12) Patent Application Publication
(10) Pub. No.: US 2014/0201043 A1
(43) Pub. Date: Jul. 17, 2014

(54) ENTITY RESOLUTION WITHOUT USING PERSONALLY IDENTIFIABLE INFORMATION

(71) Applicant: INTERNATIONAL BUSINESS MACHINES CORPORATION, Armonk, NY (US)

(72) Inventors: YOEL ARDITI, Haifa (IL); Norbert Herman, Denver, CO (US); Daniel T. Lambert, New York, NY (US)

(73) Assignee: International Business Machines Corporation, Armonk, NY (US)

(21) Appl. No.: 13/739,957

(22) Filed: Jan. 11, 2013

(51) Int. Cl. G06Q 40/00

(52) U.S. Cl. CPC G06Q 40/10
USPC 705/30

(57) ABSTRACT

In a method for tracking purchases by a customer, records of purchases forming transaction records are received, identifying a product, service, or category of product or service purchased, and a date/ time of purchase. Location records of usage of mobile devices by respective users are received, indicating a date and time of each usage and an identifier of the corresponding user. Using the transaction records and the location records, locations of the mobile devices at respective dates and times of their usage are correlated to respective locations of stores that provide products and services being purchased. Based on the dates and times of several transaction records, dates and times of several location records are matched within a predetermined time window for one customer. A determination is made that the one customer purchased one or more of the categories of products or services in the matching transaction records.

### TECHNICAL FIELD

The present invention relates generally to tracking of purchases made by a customer in a “brick and mortar” store, for example, to enable targeted promotions to the customer.

### BACKGROUND

Knowing who conducted a particular transaction, such as a purchase of a specific item or category of item from a retailer, is valuable in targeting the marketing of other products to that person.

A collection of transactions that can be related to a person can be data-mined to reveal traits, tendencies, preferences, interests, and other such information about the person (entity). However, relating a transaction to an entity is a difficult problem even within a single enterprise due to misspellings of entity names, different addresses associated with entities, and other similar issues.

For example, presently available solutions for targeted marketing attempt to match a transaction customer —an entity—to personally identifiable information (PII) to determine which customer bought which products. These solutions then personally identify the customer entity for marketing other goods and services.

Some presently available solutions leverage fuzzy logic or close-match methods in order to resolve a customer's identity. For example, a presently available algorithm can apply misspellings of names, abbreviations, or other anomaly in transactional data to determine whether a customer identified in a transaction is a person associated with certain PII.

When two or more business enterprises (hereinafter, enterprise or enterprises) want to leverage each other's customer information for cross-marketing, they presently engage in a data-sharing partnership which shares the PII of the customers and the identification of the products or categories of products that each customer purchased. Presently available solutions accept transactional data and PII from the partnering enterprises and perform the matching as described above.

The presently available solutions for data-mining transactional data of one enterprise or more than one enterprise in data-sharing partnerships rely on PII for identifying an entity. Collection, dissemination, and sharing of personally identifiable information, however, are in some jurisdictions restricted by law, terms of service, or business practices, even amongst businesses with a data sharing agreement. An object of the present invention is to enable one store to learn the buying history of a customer in another store, without exchanging the name of the customer between the two stores.

### SUMMARY

The illustrative embodiments provide a method, system, and computer program product for tracking purchases by a customer. Records of purchases forming transaction records are received, each of the transaction records identifying at least one of a product, a service, a category of the product or service purchased, and further including a date and time of purchase. Location records are received, the location records comprising records of usage of mobile devices by respective users of the mobile devices, each of the location records indicating a date and time of each usage and an identifier of the corresponding user. Using the transaction records and the location records, locations of the mobile devices at respective dates and times of their usage are correlated to respective locations of stores that provide products and services being purchased. Based on the dates and times of a plurality of the transaction records, within a predetermined time window, dates and times of a respective plurality of the location records are matched for one customer. A determination is made, by one or more processors, that the one customer purchased one or more of the categories of products or services in the matching transaction records, the one customer forming a common entity having a set of entity attributes.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a distributed computer system which implements computer processing for an embodiment of the present invention.

FIG. 3 depicts a block diagram of an example configuration for entity resolution, using hub application within a server of FIG. 1, in accordance with an illustrative embodiment;

FIG. 4 is a block diagram of a rules-based engine within a server of FIG. 1;

FIG. 5 is a flowchart of a hub application within a server of FIG. 1; and

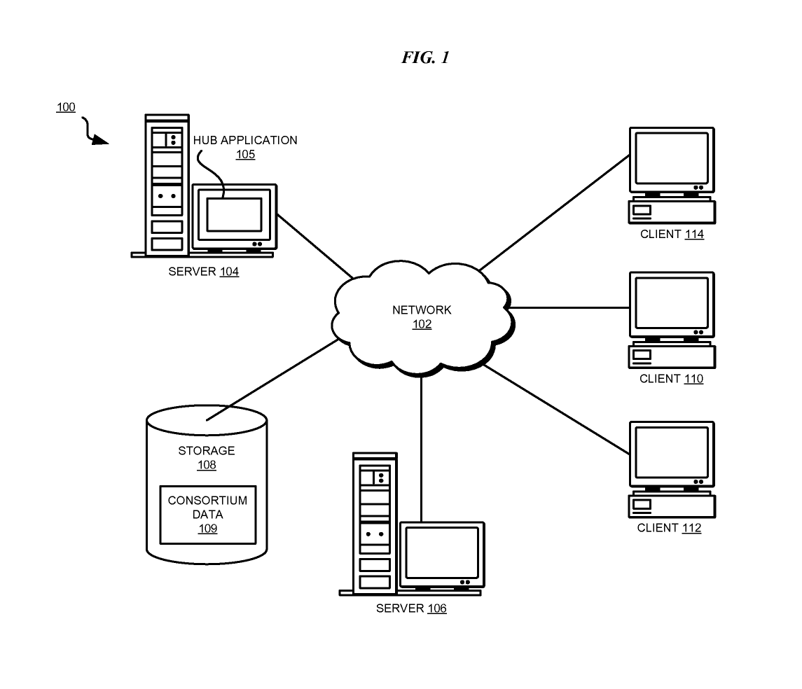

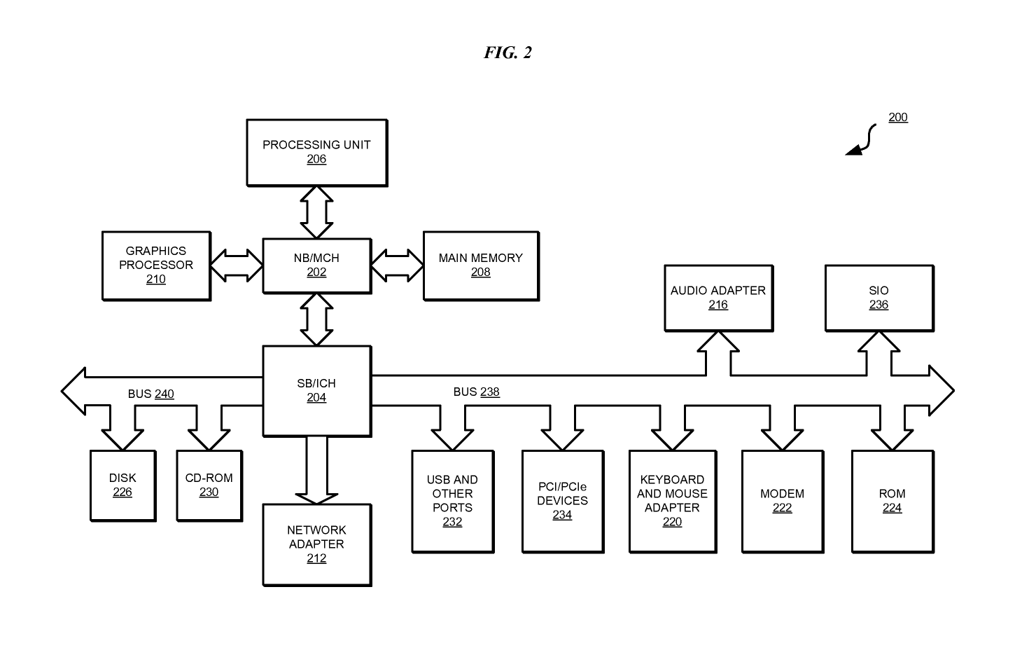

FIG. 2 depicts a block diagram of a data processing system of FIG. 1 in which illustrative embodiments may be implemented.

### DETAILED DESCRIPTION

FIG. 1 depicts a distributed data processing system generally designated 100 used in tracking customer purchases in “brick and mortar” stores according to an embodiment of the present invention. Data processing system 100 includes server computers 104 and 106, client computers 110, 112, 114, storage system 108 and network 102 which interconnects the server computers and the client computers. Network 102 may include connections, such as wire, wireless communication links, or fiber optic cables as well as routers and switches.

Hub application 105 uses consortium data 109 in storage 108 for entity resolution without using personally identifiable information. A set of enterprises contribute transaction and location data to consortium data 109.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

Within the scope of this disclosure, PII is contemplated to include that information which is usable to personally identify an entity. Name, address, social security number, and driver's license number are some examples of information that is commonly regarded as PII.

The illustrative embodiments recognize that without express data-sharing partnerships between enterprises, and without using PII, targeted marketing to entities across different enterprises is a difficult problem to solve. When access to PII is removed, presently available solutions are insufficient to determine whether an entity that conducted one transaction at one enterprise is the same as another entity that conducted another transaction at another enterprise.

The illustrative embodiments used to describe the invention generally address and solve the above-described problems and other problems related to the data-mining transaction data for marketing purposes across more than one enterprise. The illustrative embodiments provide a method, system, and computer program product for entity resolution without using personally identifiable information.

Some transactions uniformly identify an entity across different enterprises. For example, a customer may complete transactions with different enterprises using the customer's mobile phone. The mobile phone number of the customer is included as a part of such transactions. Where a customer is uniformly identifiable across transactions, such as by observing the same mobile phone number in different transactions, the entity resolution exercise is a trivial exercise. Such transaction data is not within the scope of the illustrative embodiments.

However, a majority of transactions comprise unstructured data that is not consistent across enterprises. In other words, in transaction data collected from a consortium of enterprises, the same customer is likely to be represented differently in different transactions from different enterprises. For example, customer “John Doe” may be represented as customer number 12345 at ABC retailer enterprise, and as customer number XYZ9999 at XYZ service provider enterprise. Such transaction data is within the scope of the illustrative embodiments.

The illustrative embodiments recognize that enterprises may not wish to enter into elaborate data-sharing partnerships to be able to leverage each other's data and identify cross-marketing target entities. For example, some enterprises may participate in a consortium that allows transaction data including non-personally identifiable information to be shared with one another without any express data-sharing agreement or obligation. In some cases, an enterprise may share data with a third-party service provider, such as a marketer, or a data analysis company. In such cases, sharing of PII with the third-party service provider is generally inappropriate.

The illustrative embodiments also recognize that location information is available from a variety of sources. For example, by triangulating a mobile device's signal, a telecommunication services provider can know or predict the location of the device. For example, even when a mobile device is not engaged in a user activity, the device may transition through certain cells covered by certain cell towers. If the device ceases to communicate with a cell tower at some point, the location of the device can be inferred from the previous communications with one or more cell towers.

The association between the device and a particular entity is readily established without using any PII. A location data provider, such as a telecommunication services provider, can also participate in a consortium of enterprises as another enterprise member.

An illustrative embodiment correlates the location information with transactions from a set of enterprises. A common customer may be represented differently in different transactions from different enterprises. However, by correlating the transaction data with the location data, an illustrative embodiment resolves those seemingly different customers to a common entity without using PII about the customer.

The illustrative embodiments are described with respect to certain data records and attributes only as examples. Such records or example attributes are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

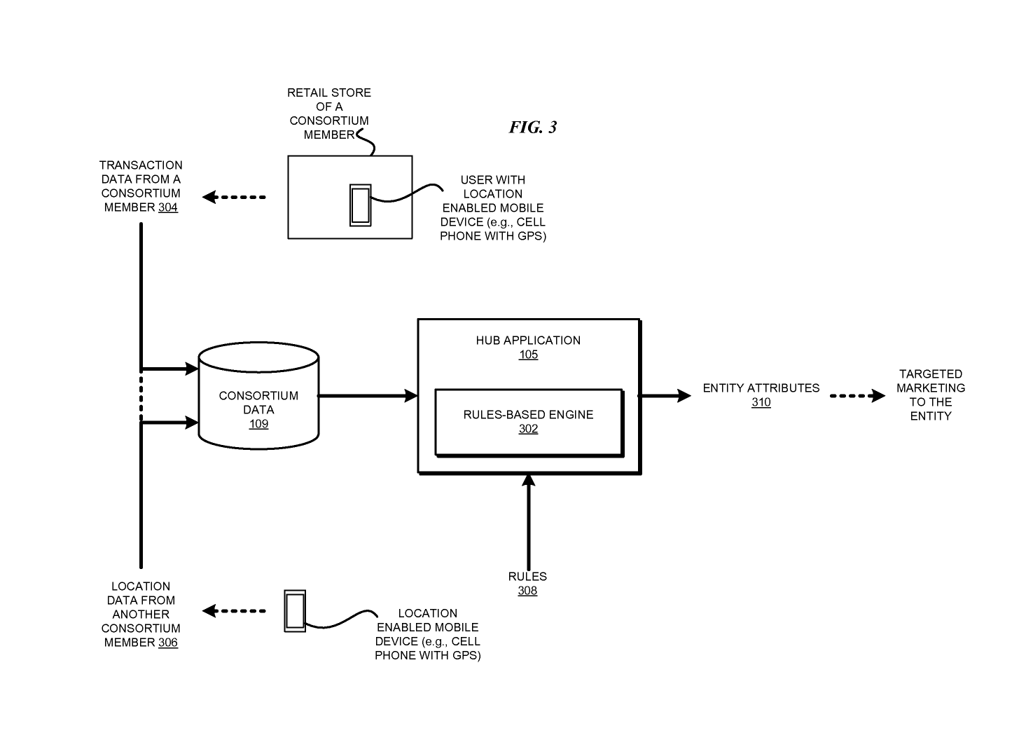

With reference to FIG. 3, hub application 105 includes rules-based engine 302, which provides the functionality for entity resolution using consortium data 109. A “brick and mortar” store location of a consortium member may have a customer therein with a location enabled mobile device, such a s a GPS enabled cell phone, as shown. Transaction data 304 from a consortium member enterprise, i.e. “brick and mortar” store, forms a part of consortium data 109. The transaction data includes the specific product or product category, date and time of each purchase as well as a customer number assigned to the customer by store which contributes the transaction data. This customer number assigned by the store is not the name or credit/debit card number of the customer, but an identifier of the customer used exclusively within the store (or collection of a chain of stores) and has no meaning outside the store or chain. A telephone or telecommunications company (“telco” which provides cell phone service or other mobile device service) is another type of consortium member that contributes location data 306 to consortium data 109. For example, a location enabled mobile device, such as a GPS equipped cell phone, may provide raw location data to the telco. For example, a telco contributes the location of the phone calls. A map database is used to correlate the location of the phone call to a store.

Entity resolution in a single member consortium, if possible, is trivial. According to the illustrative embodiments, at least two or more enterprise members contribute transaction data to consortium data 109, such that at least one of the two members contributes location data.

Rules-based engine 302 correlates the entities (e.g., mobile devices or cell phone users) identified in transaction data from different consortium member enterprises (e.g., “brick and mortar” stores), by correlating transaction data 304 with location data 306, in accordance with a set of rules 308.

Consider the following simplified example scenario to illustrate the operation of an example embodiment, without implying a limitation thereto. A customer walks into ABC retailer's store, and browses the merchandise. While present in ABC retailer's store, the customer uses his or her cell phone containing a GPS unit or other mobile device containing a GPS unit to comparison shop online, make a call, receive a text message, or to perform some other activity. The customer buys a gadget from ABC retailer's store a few minutes later using a credit card or debit card and leaves.

The purchase at ABC retailer's store creates a transaction record, transaction record 1, which ABC retailer contributes as a part of transaction data 304 to consortium data 109. The activity on the mobile device creates a location record, location record 1, which the customer's telecommunication services provider contributes as a part of location data 306 to consortium data 109. The location information (at ABC retailer's store) is correlated to the transaction data based on the date and time of the transaction matching the date and time of the use of the mobile device within a time window, such as the purchase transaction occurring within 10 minutes after the use of the mobile device.

The customer subsequently visits XYZ retailer's store. The customer's cell phone maintains connectivity to one or more base stations using messaging designed in a telecommunication protocol. The customer buys a different widget from XYZ retailer's store and leaves.

The purchase at XYZ retailer's store creates a transaction record, transaction record 2, which XYZ retailer also contributes to consortium data 109. The signaling or messaging from the mobile device creates a location record, location record 2, which the customer's telecommunication services provider also contributes as a part of location data 306 to consortium data 109. The location information (at XYZ retailer's store) is correlated to the transaction data based on the date and time of the transaction matching the date and time of the use of the mobile device within a time window, such as the purchase transaction occurring within 10 minutes after the use of the mobile device.

As an example, one example rule in rules 308 sets a time threshold. The time threshold defines a time window around a transaction in transaction data 304. Rules-based engine 302 in hub application 105 searches for a location record in location data 306 that places an entity proximate to the location of the transaction within the defined time window. If rules-based engine 302 finds such a location record in location data 306, rules-based engine 302 can correlate the transaction record with the location record.

Using the above example, using such a rule, rules-based engine 302 defines a time window around transaction record 1, which is sufficient to cover an average customer's time in store. Rules-based engine 302 finds location record 1 and associates transaction record 1 with the customer who generated location record 1. Similarly, rules-based engine 302 associates transaction record 2 with location record 2. Rules-based engine 302 further determines that location records 1 and 2 are associated with the same customer entity. Accordingly, rules-based engine 302 concludes that transaction records 1 and 2 are also associated with the same customer entity even though neither transaction record commonly identifies the customer entity.

Under certain circumstances, more than one transaction record may fall within the time window around a location record, i.e. more than one purchase transaction by more than one person in the store may be made within the time window of a mobile device usage by one person within the store. Likewise, more than one location record may fit the time window around a transaction record, i.e. more than one person may use their respective mobile devices in the store within the time window of a single purchase transaction. For example, assume that during the time window around transaction record 2, rules-based engine 302 finds location records 2, 2A, 2B, and 2C, originating from different mobile devices associated with different customer entities.

The present invention to correlate purchase transaction records with the actual purchaser (who uses the cell phone or other mobile device while in the store) is most effective in stores with a low rate of sale, such as small stores that cater to one or two customers at a time, specialty stores or stores selling high priced services or items, such as dedicated jewelry stores, furniture stores, travel agents, etc. Because of the low rate of sale, it is more likely that the user of the cell phone or other mobile device is the actual purchaser, and not someone else who happens to be in the store at the time.

Also repeat visits to the store by the same customer, as evidenced by repeated use of the cell phone or other mobile device in the store by this same customer, can improve the correlation of the customer to a category of purchase transactions, even in a store with a higher rate of sales. For example, customer A visits ABC Store five different times during which customer A uses his or her cell phone or other mobile device. In this example, ABC Store is a drug store selling a broad range of types of products and a moderate rate of sales such as 30 sales per hour, but is not a large store such as a department store with a much larger rate of sales. During three of those five visits, within the applicable time window of the usage of the cell phone or other mobile device by Customer A, ABC Store sold disposable diapers to someone. Statistically, there is a significant probability that Customer A purchased the disposable diapers at least one of the times, and therefore is a good candidate to receive promotions for baby products. At the end of the day, ABC Store provides purchase transaction records to the telco. The transaction records indicate the categories of purchases (or the actual products purchased) made by the customers at ABC Store and the date and time of each purchase, but not the identifications of the customers who made the purchases.

ABC store generates the purchase records from credit card or debit card usage by the customer, and knows the name of the customer from the credit card or debit card which is used, but cannot provide the name of the purchaser to the telco because of confidentiality rules. The telco has the location records including the date and time and location of each cell phone or mobile device usage by Customer A.

Next, the telco correlates the purchase of the disposable diapers to a specific customer of the telco based on three of the location records for Customer A matching the purchase transactions for disposable diapers at ABC store within the applicable time window. (This same algorithm for correlating a type of product to a single customer based on multiple location records for the same customer matching purchase records for the type of product can be used even when the location records indicate different stores as the locations of the calls and purchases.)

Thus, the telco has learned the identity of the purchaser of disposable diapers at ABC store without ABC Store disclosing the customer name or customer's credit/debit card number to the telco, which are all confidential. Next, the telco can advise other manufacturers and stores that the named customer is interested in baby products, so these other manufacturers and stores can target advertising and other marketing of baby products to the named customer.

Even a single location record matching a single purchase record, within the applicable time window, will provide some measure of confidence that the user of the mobile device made the purchase. While this measure alone may be insufficient to confidently target a promotion to the user, other factors can be considered as well in combination to improve the confidence, such as known demographics of the user, other purchases made by the user and learned through other channels, browsing history of the user on the mobile device, other purchases of the user made through the mobile device, etc.

Various privacy protections will be put in place. The telco, in its contract with its cell phone and other mobile device subscribers, will give the subscribers advance notice of its interest in tracking the purchases made by the subscriber, and give the subscribers the option to block this tracking. Also, the telco will not obtain purchase records for certain types of products deemed potentially embarrassing or sensitive such as names or types of prescription drugs, or the store will only disclose a category of the product at a sufficiently high level to mask the embarrassing or sensitive nature of the product such as “pharmaceutical category”.

Another example rule in rules 308 enables rules-based engine 302 to select a suitable location record from the several matching location records. For example, under certain circumstances, such as by statistical analysis of user mobility, travel history, repeat visits to XYZ store, prior correlation of the customer entity with certain enterprises, age-group based store visit predictions, consumer behavior models, or any other logic, rules-based engine 302 determines that location record 2 most suitably corresponds to transaction record 2, and not location records 2A, 2B, or 2C.

Many other rules in rules 308 may enable various other functionalities in rules-based engine 302. For example, some rules may be configured for entity disambiguation when multiple entities are likely match to a transaction. Some other example rules may enable condition based adjusting of the time thresholds, such as to accommodate increases transaction processing times during the holiday rush. Some other rules may enable rules-based engine 302 to use a second location record from a different location data provider member, such as a social networking site, to refine a correlation. The nature of the rules in rules 308 can be varied as needed according to a particular implementation and the variety is contemplated within the scope of the illustrative embodiments.

Generally, rules-based engine 302 adapts to changes in the information contained in transaction data 304, location data 306, or both. For example, rules-based engine 302 selects suitable rules from rules 308 according to the presence or absence of certain information in consortium data 109. For example, when processing a transaction record that does not have a correlating location record, rules-based engine 302 may select a rule where the rule allows using or manipulating a previously known relationship between the customer identifier and an entity.

Once rules-based engine 302 has resolved an entity, to wit, identified an entity that is associated with one or more transactions, hub application 105 outputs entity attributes 310. Entity attributes 310 includes the various identifiers used in the various transactions to identify the entity and the details of the transactions. Using the above example, entity attributes 310 can include one or more identifiers in transaction records 1 and 2 associated with the customer entity, identifiers of goods purchased, amounts, tendered, method of payments used, coupons or promotions used, or a combination thereof.

Entity attributes 310 can generally include a wide range of attributes designed to communicate a variety of information about an entity and the transactions associated with the entity. For example, in one embodiment, entity attributes 310 includes shopping preferences, brand loyalties, credit preferences, repeat purchase indicators, driving distance preference, shopping behavior indicators, list of items purchased, or a combination thereof. Many other attributes will be apparent from this disclosure to those of ordinary skill in the art and the same are contemplated within the scope of the illustrative embodiments.

Consortium data 109 does not include any PII. Hub application 105, rules-based engine 302, and rules 308 do not rely on any PII. Entity attributes 310 identify an entity only using references to the entity already present in transaction data 304.

Entity attributes 310 can include attributes not present in transaction data 304 or location data 306, derived from transaction data 304 or location data 306, recorded previously from other transaction data or location data, or a combination thereof. Entity attributes 310 are usable for any purpose, including but not limited to targeted marketing of goods and services to the resolved entity.

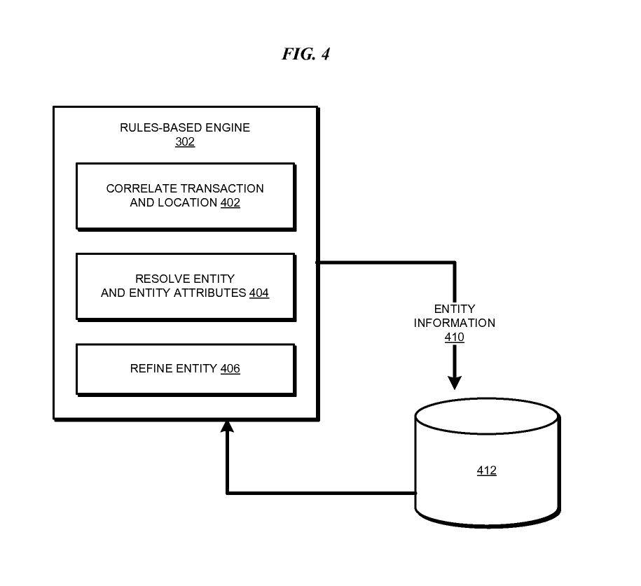

With reference to FIG. 4, this figure depicts a block diagram of another example configuration for entity resolution without using personally identifiable information in accordance with an illustrative embodiment. Rules-based engine 302 is an example embodiment of rules-based engine 302 in FIG. 3.

Rules-based engine 302 includes example component 402, which correlates the transaction records and location records in the manner described with respect to FIG. 3. Component 404 resolves the entity and entity attributes in the manner described with respect to FIG. 3.

Component 406 refines an entity's information. For example, rules-based engine 302 outputs the resolved entity and entity attributes in the form of entity information 410, which is stored in entity repository 412. Entity information repository serves as an additional input to rules-based engine 302 and provides existing entity information to rules-based engine 302. In conjunction with rules 308 in FIG. 3, the existing entity information from repository 412 aids rules-based engine 302 in correlating records, filtering undesirable records, resolving conflicts amongst disparate records, eliminating duplicates, identifying correlation using known attributes of an entity, and other similar purposes.

Component 406 uses the resolved entity and entity attributes from component 404, compares them with the entity information for the same entity stored in repository 412, and augments, updates, changes, corrects, modifies, or otherwise manipulates entity information 410. Such operations of component 406 result in improved data collection about the entities in repository 412, which in turn results in better or faster entity resolution in subsequent transactions.

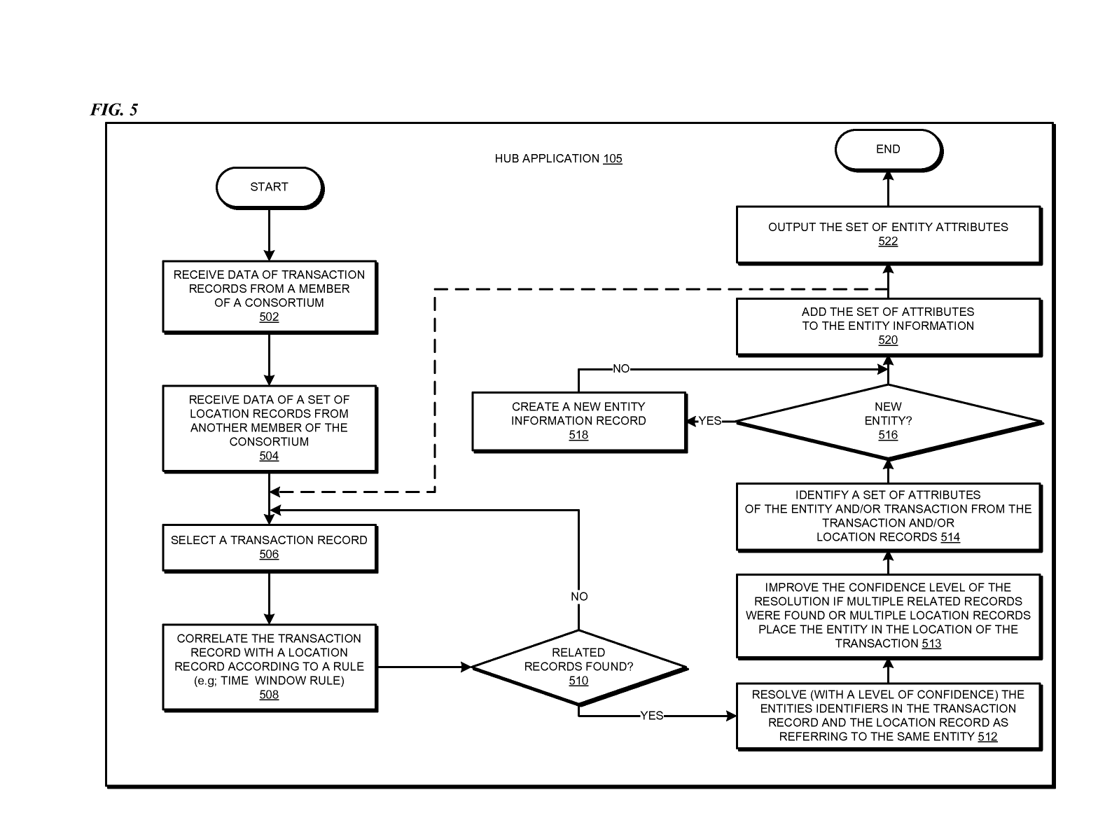

With reference to FIG. 5, this figure depicts a flowchart of an example process for entity resolution without using personally identifiable information in accordance with an illustrative embodiment. Process 500 can be implemented in hub application 105, such as in rules-based engine 302 in FIG. 3.

Hub application 105 receives a set of transaction records, such as transaction records 304 in FIG. 3, from one or more members of a consortium of enterprises (step 502). Hub application 105 receives a set of location records, such as location records 306 in FIG. 3, from one or more other members of the consortium of enterprises (step 504).

Hub application 105 selects a transaction record (step 506). Hub application 105 correlates the transaction record with a location record according to a rule, such as the example time window rule described with respect to FIG. 3 (step 508). Hub application 105 determines whether related transaction and location records were found (step 510). If related records were not found according to any rule (“No” path of step 510), hub application 105 returns to step 506 of the process to select another transaction.

One embodiment determines that the entity of the uncorrelated transaction record cannot be determined without additional information, such as by using PII according to an existing tool, and drops the uncorrelated transaction record from further correlation efforts. In another embodiment (not shown), hub application 105 may loop back and select at step 506, a previously uncorrelated transaction record, after some other correlations have been performed, such that the entity information from subsequent correlations can aid in resolving the entity of the previously uncorrelated transaction record.

If related records were found according to some rule (“Yes” path of step 510), hub application 105 resolves the entity identifiers in the transaction record and the location record as referring to the same entity (step 512). Hub application 105 allocates a level of confidence to the resolution of step 512 based on a variety of factors, such as described elsewhere in this disclosure. Hub application 105 improves the confidence level of the resolution when multiple matching records are found in step 510, multiple location records over a period of time place the entity at the location of the transaction (step 513).

Hub application 105 identifies a set of attributes of the entity, transaction, or both, from the correlated transaction and location records (step 514).

Hub application 105 determines whether the identified entity is a new entity, to wit, not an entity that present in an entity information repository (step 516). If the entity is a new entity (“Yes” path of step 516), hub application 105 creates a new entity information record for the entity (step 518) and proceeds to step 520. If the entity is not a new entity (“No” path of step 516), hub application 105 adds the set of attributes to the entity information (step 520). Adding the set of attributes in step 520 may modify an existing set of attributes associated with the existing entity information record.

In one embodiment, hub application 105 returns to step 506 to select another transaction, such as a from another consortium member. Correlating different transactions from different member enterprises of the consortium allows hub application 105 to broaden the set of attributes identified in step 514. A broader set of attributes allows, for example, improved targeting for cross-marketing of goods and services.

Hub application 105 outputs the set of entity attributes, such as all or a subset of attributes current in the entity information in a repository (step 522). Hub application 105 ends process 500 thereafter.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. A computer readable or usable storage device does not include propagation media. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as hub application 105 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non- volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for entity resolution without using personally identifiable information. Using an embodiment, a hub application identifies common entities across a variety of transactions occurring at various enterprises. The entity and characteristics of the entity are identified without using any PII about the entity, but by correlating the transaction data with location data according to a set of rules.

The entity attributes can be shared with marketers of goods and services, including but not limited to the enterprises that contribute parts of the transaction or location data. Furthermore, the entity attributes can be used to generate aggregate statistics or normalized behavior patterns, which can be provided to contributing enterprises, or third-party marketers.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro- code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) having computer readable program code embodied thereon.

Any combination of one or more computer readable storage device(s) may be utilized. The term “computer readable storage device” encompasses an electronic, magnetic, optical, electromagnetic, infrared, or semiconductor system, apparatus, or device, or any suitable combination of the foregoing, but does not encompass a signal propagation media such as wires, optical cables or wireless transmission media. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible device that can store but does not propagate a program for use by or in connection with an instruction execution system, apparatus, or device.

Program code may be transmitted by wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices that can direct one or more computers, one or more other programmable data processing apparatuses, or one or more other devices to function in a particular manner, such that the instructions stored in the one or more computer readable storage devices produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A method for tracking purchases by a customer, the method comprising the steps of:
Receiving records of purchases forming transaction records, each of the transaction records identifying at least one of a product, a service, a category of the product or service purchased, and further including a date and time of purchase;
receiving location records, the location records comprising records of usage of mobile devices by respective users of the mobile devices, each of the location records indicating a date and time of each usage and an identifier of the corresponding user;
correlating using the transaction records and the location records, locations of the mobile devices at respective dates and times of their usage to respective locations of stores that provide products and services being purchased; and
based on the dates and times of a plurality of the transaction records, matching, within a predetermined time window, dates and times of a respective plurality of the location records for one customer, determining, by one or more processors, that the one customer purchased one or more of the categories of products or services in the matching transaction records, the one customer forming a common entity having a set of entity attributes.

2. The method of claim 1, wherein the plurality of transaction records identify a plurality of purchases of products in a same category.

3. The method of claim 1, further comprising:
receiving, using the one or more processors, the set of transaction records, wherein a first transaction data provider provides a first subset of the set of transaction records; and
receiving, using the one or more processors, the set of location records, wherein a first location data provider provides a first subset of the set of location records.

4. The method of claim 3, wherein a second transaction data provider provides a second subset of the set of transaction records, wherein a second location data provider provides a second subset of the set of location records, and wherein the second subset of location records is used in the resolving to resolve a conflict in identifying the entity.

5. The method of claim 1, wherein the correlating results in a plurality of correlated location records, the location record being one of the plurality of correlated location records, further comprising:
selecting, using the one or more processors, the location record from the plurality of correlated location records, wherein the selecting uses a rule for preferring the location record to other records in the plurality of correlated location records.

6. The method of claim 5, wherein the rule uses a second location record from a second location data provider in the set of location records.

7. The method of claim 5, wherein the rule uses a previously recorded characteristic of the common entity.

8. The method of claim 1, further comprising:
performing, using the one or more processors, the selecting, the correlating, and the resolving, with a second transaction record from a second transaction data provider in the set of transaction records.

9. The method of claim 8, wherein the performing enables a first transaction data provider of the selected transaction record to use an entity attribute generated from the second transaction record from the second transaction data provider in a service directed to the common entity.

10. The method of claim 1, further comprising:
identifying, using the one or more processors, the set of entity attributes using the selected transaction record and the correlated location record, wherein a first attribute in the set of entity attributes is indicative of a characteristic of the common entity, and a second attribute in the set of entity attributes is indicative of a product in the selected transaction.

11. The method of claim 10, wherein a third attribute in the set of entity attributes is indicative of a preference made by the common entity in the selected transaction.

12. The method of claim 1, further comprising:
adding, using the one or more processors, the set of entity attributes to a repository of entity information.

13. The method of claim 12, wherein the adding modifies a previously existing set of entity attributes associated with a previously existing entity information record of the common entity in the repository.

14. The method of claim 13, wherein the resolving uses the previously existing entity information record.

15. The method of claim 1, wherein the outputting further comprises one of:
associating, using the one or more processors, the set of entity attributes with the one customer and providing the set of entity attributes to a first transaction data provider that provides the selected transaction record; and
aggregating, using the one or more processors, the set of entity attributes with another set of entity attributes associated with a second entity to create an aggregated set of entity attributes, and providing the aggregated set of entity attributes to a third-party user.

16. A computer program product comprising one or more computer-readable storage devices and computer-readable program instructions which are stored on the one or more storage devices and when executed by the one or more processors of claim 1 perform the method of claim 1.

17. A computer comprising the one or more processors, one or more computer- readable memories, one or more computer-readable storage devices and program instructions which are stored on the one or more storage devices for execution by the one or more processors via the one or more memories and when executed by the one or more processors perform the method of claim 1.

18. A computer program product for tracking purchases by a customer, the computer program product comprising:
one or more computer-readable storage devices and program instructions stored on at least one of the one or more storage devices, the program instructions comprising:
program instructions to receive records of purchases forming transaction records, each of the transaction records identifying at least one of a product, a service, a category of the product or service purchased, and further including a date and time of purchase;
program instructions to receive location records, the location records comprising records of usage of mobile devices by respective users of the mobile devices, each of the location records indicating a date and time of each usage and an identifier of the corresponding user;
program instructions to correlate, using the transaction records and the location records, locations of the mobile devices at respective dates and times of their usage to respective locations of stores that provide products and services being purchased; and
based on the dates and times of a plurality of the transaction records, program instructions to match, within a predetermined time window, dates and times of a respective plurality of the location records for one customer, program instructions to determine, by one or more processors, that the one customer purchased one or more of the categories of products or services in the matching transaction records, the one customer forming a common entity having a set of entity attributes.

19. The computer program product of claim 18, wherein the plurality of transaction records identify a plurality of purchases of products in a same category.

20. A computer system for tracking purchases by a customer, the computer system comprising:
one or more processors, one or more computer-readable memories, one or more computer-readable storage devices, and program instructions stored on at least one of the one or more storage devices for execution by at least one of the one or more processors via at least one of the one or more memories, the program instructions comprising:
first program instructions to receive records of purchases forming transaction records, each of the transaction records identifying at least one of a product, a service, a category of the product or service purchased, and further including a date and time of purchase;
second program instructions to receive location records, the location records comprising records of usage of mobile devices by respective users of the mobile devices, each of the location records indicating a date and time of each usage and an identifier of the corresponding user;
third program instructions to correlate, using the transaction records and the location records, locations of the mobile devices at respective dates and times of their usage to respective locations of stores that provide products and services being purchased; and
based on the dates and times of at least one transaction record, fourth program instructions to match, within a predetermined time window, dates and times of at least one location record for one customer, fifth program instructions to determine, by one or more processors, that the one customer purchased one or more of the categories of products or services in the matching at least one transaction record, the one customer forming a common entity having a set of entity attributes.
